(19) United States
(12) Patent Application Publication
(10) Pub. No.: US 2019/0233310 A1
(43) Pub. Date: Aug. 1, 2019

(54) ACOUSTIC MIXING FOR FLOCCULANT ADDITION TO MINERAL SUSPENSIONS

(71) Applicant: DOW GLOBAL TECHNOLOGIES LLC, Midland, MI (US)

(72) Inventors: Carol E. MOHLER, Midland, MI (US); Michael K. POINDEXTER, Sugar Land, TX (US); Thomas L. SANDERS, JR., Saginaw, MI (US); Cole A. WITHAM, Pearland, TX (US)

(73) Assignee: Dow Global Technologies LLC, Midland, MI (US)

(21) Appl. No.: 16/315,751

(22) PCT Filed: Jul. 18, 2017
(86) PCT No.: PCT/US2017/042569

§ 371 Date: Jan. 7, 2019

Related U.S. Application Data
(60) Provisional application No. 62/366,206, filed on Jul. 25, 2016.

(51) Int. Cl. C02F 1/34; C02F 11/147; C02F 1/56; C02F 1/52; B01F 3/12; C02F 1/38; C10G 1/04

(52) U.S. Cl. CPC C02F 1/34; C02F 11/147; C02F 1/56; C02F 1/5272; C02F 2103/10; B01F 3/1271; C02F 1/38; C10G 1/045; B01F 3/1242

(57) ABSTRACT

The present invention relates to a process for mixing a flocculant composition with mineral suspensions, especially waste mineral slurries, using an acoustic mixer. Preferably the flocculant composition is a polymeric flocculant composition preferably comprising a poly(ethylene oxide) homopolymer or copolymer. The process of the present invention is particularly suitable for the treatment of tailings and other waste material resulting from mineral processing, in particular, processing of oil sands tailings.

### FIELD OF THE INVENTION

The present invention relates to a process for mixing a flocculant composition with mineral suspensions, especially waste mineral slurries, using an acoustic mixer. The flocculant composition is a polymeric flocculant composition preferably comprising a poly(ethylene oxide) homopolymer or copolymer. The process of the present invention is particularly suitable for the treatment of tailings and other waste material resulting from mineral processing, in particular, processing of oil sands tailings.

### BACKGROUND OF THE INVENTION

Fluid tailings streams derived from mining operations, such as oil sands mining operations, are typically composed of water and solid particles. In order to recover the water and consolidate the solids, solid/liquid separation techniques must be applied. In oil sands processing a typical fresh tailings stream comprises water, sand, silt, clay and residual bitumen. Oil sands tailings typically comprise a substantial amount of fine particles (which are defined as solids that are less than 44 microns).

The bitumen extraction process utilizes hot water and chemical additives such as sodium hydroxide or sodium citrate to remove the bitumen from the ore body. The side effect of these chemical additives is that they can change the inherent water chemistry. The inorganic solids as well as the residual bitumen in the aqueous phase acquire a negative charge. Due to strong electrostatic repulsion, the fine particles form a stabilized suspension that does not readily settle by gravity, even after a considerable amount of time. In fact, if the suspension is left alone for 3-5 years, a gel-like layer known as mature fine tailings (MFT) will be formed and this type of tailings is very difficult to consolidate further even with current technologies.

Recent methods for dewatering MFT are disclosed in WO 2011/032258 and WO 2001/032253, which describe in-line addition of a flocculant solution, such as a polyacrylamide (PAM), into the flow of oil sands tailings, through a conduit such as a pipeline. Once the flocculant is dispersed into the oil sands tailings, the flocculant and tailings continue to mix as they travel through the pipeline and the dispersed fine clays, silt, and sand bind together (flocculate) to form larger structures (flocs) that can be separated from the water when ultimately deposited in a deposition area. However, the degree of mixing and shearing is dependent upon the flow rate of the materials through the pipeline as well as the length and diameter of the pipeline. Thus, any changes in the fluid properties or flow rate of the oil sands fine tailings may have an effect on both mixing and shearing and ultimately flocculation. Thus, if one has a length of open pipe, it can be difficult to control flocculation because of the difficulty in independently controlling both the shear rate and residence time simply by changing the flow rate.

CA Patent Application No. 2,512,324 suggests addition of water-soluble polymers to oil sands fine tailings during the transfer of the tailings as a fluid to a deposition area, for example, while the tailings are being transferred through a pipeline or conduit to a deposition site. However, once again, proper mixing of polymer flocculant with tailings is difficult to control due to changes in the flow rate and fluid properties of the tailings material through the pipeline.

US Publication No. 2013/0075340 discloses a process for flocculating and dewatering oil sands tailings comprising adding oil sands tailings as an aqueous slurry to a stirred tank reactor; adding an effective amount of a polymeric flocculant, such as charged or uncharged polyacrylamides, to the stirred tank reactor containing the oil sands tailings, dynamically mixing the flocculant and oil sands tailings for a period of time sufficient to form a gel-like structure; subjecting the gel-like structure to shear conditions in the stirred tank reactor for a period of time sufficient to break down the gel-like structure to form flocs and release water; and removing the flocculated oil sands fine tailings from the stirred tank reactor when the maximum yield stress of the flocculated oil sands fine tailings begins to decline but before the capillary suction time of the flocculated oil sands fine tailings begins to substantially increase from its lowest point.

While polyacrylamides are generally useful for fast consolidation of tailings solids, they are highly dose sensitive towards the flocculation of fine particles, and it is challenging to find conditions under which a large proportion of the fine particles are flocculated. As a result, the water recovered from a PAM consolidation process is often of poor quality and may not be good enough for recycling because of high fines content in the water. Additionally, tailings treated with PAM are shear sensitive so transportation of treated thickened tailings to a dedicated disposal area (DDA) and general materials handling can become a further challenge. Alternatively, polyethylene oxide (PEO) is known as a flocculant for mine tailings capable of producing a lower turbidity supernatant as compared to PAM, for example see U.S. Pat. Nos. 4,931,190; 5,104,551; 6,383,282; WO 2011070218; Sharma, S. K., Scheiner, B. J., and Smelley, A. G., (1992). Dewatering of Alaska Pacer Effluent Using PEO. United States Department of the Interior, Bureau of Mines, Report of Investigation 9442; and Sworska, A., Laskowski, J. S., and Cymerman, G. (2000). Flocculation of the Syncrude Fine Tailings Part II. Effect of Hydrodynamic Conditions. Int. J. Miner. Process., 60, pp. 153-161. However, PEO homopolymers and copolymers have not found widespread commercial use in oil sands tailing treatment because of mixing and processing challenges resulting from its high viscosities with clay-based slurries.

In spite of the numerous processes and polymeric flocculating agents used therein, there is still a need for a flocculating process to further improve the settling and consolidation of suspensions of materials as well as further improve upon the dewatering of suspensions of waste solids that have been transferred as a fluid or slurry to a settling area for disposal. In particular, it would be desirable to provide a more effective treatment of waste suspensions, such as oil sands tailings, transferred to disposal areas ensuring improved concentration of solids and improved clarity of released water with improved shear stability and wider dose tolerance.

### BRIEF SUMMARY OF THE INVENTION

The present invention is a process for flocculating and dewatering a mineral suspension, preferably an aqueous suspension of oil sands tailings, comprising the steps: i) providing a mineral suspension to an acoustic mixer, ii) providing a flocculant composition to said acoustic mixer, preferably the flocculant is added to the mineral suspension before, during, or after addition to the acoustic mixer, and iii) acoustically mixing the mineral suspension and the flocculant composition to provide a flocculated mineral suspension.

One embodiment of the process of the present invention described herein above further comprises the step: ii) a) providing a coagulant to said acoustic mixer.

One embodiment of the process of the present invention described herein above further comprises the step: iv) adding the conditioned flocculated oil sands fine tailings to at least one centrifuge to dewater the flocculated oil sands fine tailings and form a high solids cake and a low solids centrate.

Another embodiment of the process of the present invention described herein above further comprises the step: v) adding the conditioned flocculated oil sands fine tailings to a thickener to dewater the flocculated oil sands fine tailings and produce thickened oil sands fine tailings and clarified water.

Another embodiment of the process of the present invention described herein above further comprises the step: vi) adding the conditioned flocculated oil sands fine tailings to at least one deposition cell such as an accelerated dewatering cell for dewatering.

Another embodiment of the process of the present invention described herein above further comprises the step: vii) spreading the conditioned flocculated oil sands fine tailings as a thin layer onto a sloped deposition site.

In one embodiment of the process of the present invention disclosed herein above, the flocculant composition comprises one or more of a polyacrylate, a polymethacrylate, a polyacrylamide, a partially-hydrolyzed polyacrylamide, a poly(ethylene oxide) homopolymer, a poly(ethylene oxide) copolymer, a cationic derivatives of polyacrylamide, a polydiallyldimethylammonium chloride (pDADMAC), a copolymer of DADMAC, a cellulosic material, a chitosan, a sulfonated polystyrene, a linear and/or branched polyethyleneimine, a polyvinylamine, a polyalkylene glycol, a polyquat/hyalauronic acid, a polyacrylic, a polyacrylamide (acrylic acid) copolymer, a poly(acrylamide-co-diallyl dimethylammonium chloride), guar, a hydrophobically alkali-soluble emulsion, an alkali-swellable emulsion, a hydrophobically modified ethoxylated urethane polymer, or mixtures thereof.

In one embodiment of the process of the present invention disclosed herein above, the poly(ethylene oxide) polymer is a poly(ethylene oxide) copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

In one embodiment of the process of the present invention disclosed herein above, the poly(ethylene oxide) (co)polymer has a molecular weight of equal to or greater than 1,000,000 Da, preferably 8,000,000 Da.

### BRIEF DESCRIPTION OF THE DRAWINGS

FIG. 1 is a schematic of embodiments A to D of the process of the present invention.

### DETAILED DESCRIPTION OF THE INVENTION

According to the present invention, we provide a process for dewatering a mineral suspension comprising acoustically mixing the suspension with a flocculating composition. Typically, the material to be flocculated is a mineral suspension and may be derived from or contain filter cake, industrial tailings, thickener underflows, legacy tailings (sometimes called mature fine tailings), fluid fine tailings, fine tailings, froth tailings, flotation tailings, or unthickened plant waste streams, for instance other mineral tailings, slurries, or slimes, including phosphate, diamond, gold slimes, mineral sands, tails from zinc, lead, copper, silver, uranium, nickel, iron ore processing, coal, oil sands or red mud. The material may be solids settled from the final thickener or wash stage of a mineral processing operation. Thus the material desirably results from a mineral processing operation. Preferably the material comprises tailings. Preferably the mineral material would be selected from red mud and tailings containing clay, such as oil sands tailings, etc.

The oil sands tailings or other mineral suspensions may have a solids content in the range 5 percent to 80 percent by weight. The slurries or suspensions often have a solids content in the range of 10 percent to 70 percent by weight, for instance 25 percent to 40 percent by weight. The sizes of particles in a typical sample of the fine tailings are substantially all less than 45 microns, for instance about 95 percent by weight of material is particles less than 20 microns and about 75 percent is less than 10 microns. The coarse tailings are substantially greater than 45 microns, for instance about 85 percent is greater than 100 microns but generally less than 10,000 microns. The fine tailings and coarse tailings may be present or combined together in any convenient ratio provided that the material remains pumpable.

The dispersed particulate solids may have a unimodal, bimodal, or multimodal distribution of particle sizes. The distribution will generally have a fine fraction and a coarse fraction, in which the fine fraction peak is substantially less than 44 microns and the coarse (or non-fine) fraction peak is substantially greater than 44 microns.

The flocculating composition of the present invention comprises one or more flocculant selected from polyacrylates, polymethacrylates, polyacrylamides, partially-hydrolyzed polyacrylamides, poly(ethylene oxide) homopolymers, poly(ethylene oxide) copolymers, cationic derivatives of polyacrylamides, polydiallyldimethylammonium chloride (pDADMAC), copolymers of DADMAC, cellulosic materials, chitosan, sulfonated polystyrene, linear and branched polyethyleneimines, polyvinylamines, polyalkylene glycols, polyquat/hyalauronic acids, polyacrylics, polyacrylamide (acrylic acid) copolymers, poly(acrylamide-co-diallyl dimethylammonium chloride), guar, hydrophobically alkali-soluble emulsions, alkali-swellable emulsions, hydrophobically modified ethoxylated urethane polymers, or mixtures thereof. A preferable flocculant comprises a poly(ethylene oxide) homopolymer, a poly(ethylene oxide) copolymer, or mixtures thereof, herein after collectively referred to as “poly(ethylene oxide) (co)polymer”.

A suitable amount of the flocculant to be added to the mineral suspensions range from 10 grams to 10,000 grams per ton of dry mineral solids. Generally the appropriate dose can vary according to the particular material and material solids content. Preferred doses are in the range 30 to 7,500 grams per ton, more preferably 100 to 3,000 grams per ton, while even more preferred doses are in the range of from 500 to 3,000 grams per ton. The flocculant composition may be added to the suspension of particulate mineral material, e.g., the tailings slurry, in solid particulate form, an aqueous solution that has been prepared by dissolving and/or suspending the flocculant into water, or an aqueous-based medium, or a suspended slurry in a solvent.

The flocculant composition of the process of the present invention comprises, consists essentially of, or consists of a polymeric flocculant, preferably poly(ethylene oxide) homopolymer, a poly(ethylene oxide) copolymer, or mixtures thereof. Poly(ethylene)oxide (co)polymers and methods to make said polymers are known, for example see WO 2013116027.

Suitable poly(ethylene oxide) homopolymers and poly(ethylene oxide) copolymers useful in the method of the present invention have a weight average molecular weight equal to or greater than 100,000 daltons (Da) and equal to or less than 15,000,000 Da, preferably equal to or greater than 1,000,000 Da and equal to or less than 8,000,000 Da.

Poly(ethylene oxide) (co)polymers are particularly suitable for use in the method of the present invention as flocculation agents for suspensions of particulate material, especially waste mineral slurries. Poly(ethylene oxide) (co)polymers are particularly suitable for the method of the present invention to treat tailings and other waste material resulting from mineral processing, in particular, processing of oil sands tailings.

In the process of the present invention, the flocculant composition comprising a poly(ethylene oxide) (co)polymer may further comprise, consist essentially of, or consist of one or more other types of flocculant (e.g., polyacrylates, polymethacrylates, polyacrylamides, partially-hydrolyzed polyacrylamides, cationic derivatives of polyacrylamides, polydiallyldimethylammonium chloride (pDADMAC), copolymers of DADMAC, cellulosic materials, chitosan, sulfonated polystyrene, linear and/or branched polyethyleneimines, polyvinylamines, etc.) or other type of additive typical for flocculant compositions.

For example, an additive typical for flocculant compositions is a coagulant. Suitable coagulants are salts of calcium (e.g., gypsum, calcium oxide, and calcium hydroxide), aluminum (e.g., aluminum chloride, sodium aluminate, and aluminum sulfate), iron (e.g., ferric sulfate, ferrous sulfate, ferric chloride, and ferric chloride sulfate), magnesium (e.g., magnesium chloride or magnesium carbonate), other multi-valent cations and pre-hydrolyzed inorganic coagulants, may also be used in conjunction with the flocculant composition, preferably with a poly(ethylene oxide) (co)polymer.

In one embodiment, the present invention relates to a process for dewatering oil sands tailings. As used herein, the term “tailings” means tailings derived from oil sands extraction operations and containing a fines fraction. The term is meant to include fluid fine tailings (FFT) and/or mature fine tailings (MFT) tailings from ongoing extraction operations (for example, thickener underflow or froth treatment tailings) which may bypass a tailings pond and from tailings ponds. The oil sands tailings will generally have a solids content of 10 to 70 weight percent, or more generally from 25 to 40 weight percent, and may be diluted to 20 to 25 weight percent with water for use in the present process.

Acoustic-Mixing Process and Machine:

The process of the present invention comprises the step of acoustically mixing a flocculant, preferably a polymeric flocculant, more preferably a poly(ethylene oxide) (co)polymer with a mineral suspension or mineral slurries. The process of the present invention is particularly suitable for the treatment of tailings and other waste material resulting from mineral processing, in particular, processing of oil sands tailings.

Acoustic mixing introduces acoustic energy into liquids, slurries, powders and pastes. “Acoustic mixer” is a term used to describe a broad-based machine that causes acoustic oscillations.

The underlying principle of operations for an acoustic-mixing machine include the use of mechanical energy from an electrical or hydraulic motor to rotate an eccentric drive assembly that is coupled to a mechanical member e.g., one or more bars or plates, weights, or springs. Some common members are a specially treated solid steel bar and a hollow tube resonator (HTR). The rotational frequency of the oscillator is adjusted to bring this mechanical member into resonance and the energy is then acoustically transferred to the material to be mixed.

Acoustic mixing is distinct from conventional impeller agitation found in a planetary mixer or speed mixer as well as ultrasonic mixing. Low frequency, high-intensity acoustic energy is used to create a uniform shear field throughout the entire mixing vessel. The result is rapid fluidization (like a fluidized bed) and dispersion of material.

Acoustic mixing differs from ultrasonic mixing in that the frequency of acoustic energy is orders of magnitude lower. As a result, the scale of mixing is larger. Unlike impeller agitation, which mixes by inducing bulk flow, the mixing occurs on a microscale throughout the mixing volume.

Issues that may arise with the use of conventional mixers that possess impellers include, but are not limited to, a moderate mixing cycle (longer time to accomplish mixing); limited high-viscosity mixing capability; viscous heating; limited filler loading capability; high shear localized mixing; it requires contact mixing, and thus impeller cleaning is an additional step that must be utilized in the process; and the process includes mixing and transferring to a container, followed by shipping.

To the contrary, advantages to be found by using an acoustic mixer include, but are not limited to, fast mixing cycle; excellent high-viscosity mixing capability; low heat generation; high rate of filler loading; high intensity mixing throughout the volume of material to be mixed; non-contact, hygienic, sealed mixing; and a shorter process.

The selected acoustic mixer in accordance with the present invention provides intimate mixing by applying a consistent shear field throughout the entire vessel, and thus may be especially suitable for the mixing of viscous polymers, solids, powders, or materials of dissimilar viscosities.

Suitable acoustic mixers are within the purview of those skilled in the art. In one embodiment of the process of the present invention, the acoustic mixer may include a closed vessel without impellers, which uses low-frequency, high intensity acoustic energy to provide the desired mixing.

A suitable acoustic mixer for use in accordance with the present disclosure includes LABRAM™ mixers, without impellers, commercially available from Resodyn Acoustic Mixers, Inc. (Butte, Mont.) The acoustic mixer is operated at a resonant frequency. A closely controlled electromechanical oscillator is used to excite the mix material. The acoustic mixer may operate at a frequency of from about 10 Hertz to about 200 Hertz, preferably from about 30 Hertz to about 100 Hertz. The entire system may oscillate in resonance, allowing highly efficient energy transfer and rapid mixing of the components of the mixture.

Preferably, a suitable acoustic mixer may handle polymer solutions with a viscosity up to about 100 million centipoise (cP), preferably from about 1 cP to about 80 million cP. Compared with an impeller-based mixer, an acoustic mixer can easily achieve good mixing within a very short time, in embodiments from 5 seconds to 300 minutes, in other embodiments from 30 seconds to 60 minutes.

In one embodiment of the process of the present invention, the flocculant composition is introduced to the aqueous MFT in the acoustic mixer as an aqueous mixture.

In one embodiment of the process of the present invention, the flocculant and MFT compositions come into contact before they enter the acoustic mixer, at the point they both enter the acoustic mixer, or after they have each entered the acoustic mixer.

In another embodiment of the process of the present invention, the flocculant composition is introduced directly to the aqueous MFT in the acoustic mixer in its neat form (i.e., as a powder, a paste, a liquid, etc.).

In one embodiment the process of the present invention is a batch process.

In another embodiment the process of the present invention is a continuous process.

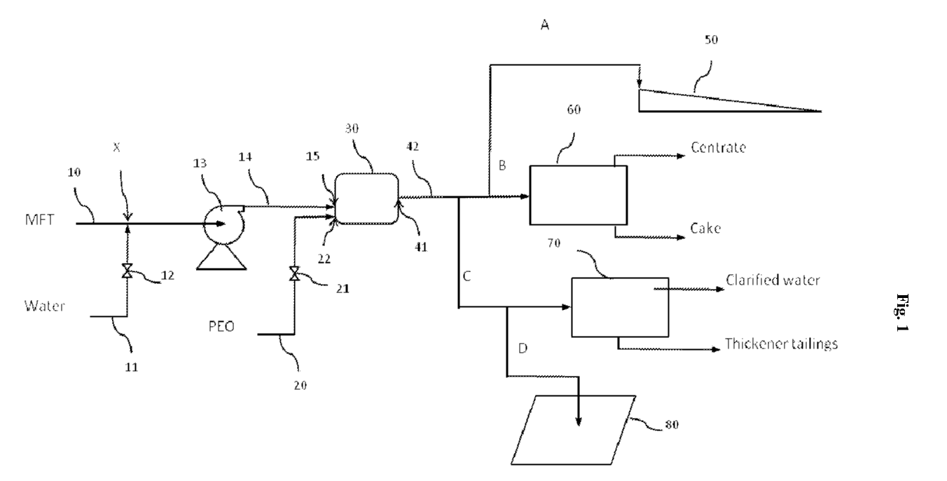

A schematic of four embodiments, A, B, C and D, of the present invention is shown in FIG. 1. In one embodiment, a mineral suspension, for example, an aqueous suspension of oil sands mature fine tailings (MFT) in line 10 are pumped via pump 13 through a transportation conduit, preferably a first pipeline, line 14. If desired, additional water can be added to the MFT through line 11 at Point X. The MFT enters the acoustic mixer 30 through mixer inlet pipes 15. In one embodiment (shown in FIG. 1), the flocculant composition, for example comprising a poly(ethylene oxide) (co)polymer (referred herein after to as “PEO”), is added to the acoustic mixer 30 as an aqueous mixture through line 20 at mixer inlet pipe 22. In another embodiment (not shown in FIG. 1) the flocculant composition is added neat directly to the acoustic mixer 30 as a powder. In yet another embodiment (not shown in FIG. 1) an additional additive, such as a coagulant, is added to acoustic mixer 30 before or during mixing.

The process of the present invention is conducted in an acoustic mixer 30 located between a first pipe 14 in which material enters the acoustic mixer 30 and a second pipe 42 in which material exits the acoustic mixer 30. Once material has exited the acoustic mixer 30 it may be further conditioned, treated and/or deposited in a sloped deposition area. Generally, the line 14 which enters the acoustic mixer 30 is the same (i.e., the same diameter) as the line 42 which leaves the acoustic mixer 30, however the line 14 which enters the acoustic mixer 30 may have a larger diameter than line 42 which leaves the acoustic mixer 30, or the line 14 which enters the acoustic mixer 30 may have a smaller diameter than line 42 which leaves the acoustic mixer 30. Typical industrial tailings pipeline 14 diameters are in the range from 8 inches to 36 inches.

After leaving the in-line acoustic mixer 30 the acoustically mixed solution of MFT and PEO comprising floc exits through line 42. In one embodiment, once the acoustically mixed solution of MFT and PEO leaves the acoustic mixer 30 through line 42 it is allowed to continue to build floc, sometimes referred to as conditioning, before deposition or further treatment.

Line 42 may comprise a static mixer, a small tank, an enlarged diameter section of piping, or a length of pipe with or without bends to create a favorable hydrodynamic environment for conditioning the fluid mixture. Preferably conditioning is allowed to take place for at least 5 seconds, preferably at least 10 seconds, preferably at least 15 seconds, more preferably at least 20 seconds, more preferably at least 30 seconds, and more preferably at least 45 seconds. The upper time limit for conditioning is whatever is practical for the particular process, but typically, an adequate time for conditioning is equal to or less than an hour, equal to or less than 30 minutes, more preferably equal to or less than 10 minutes, more preferably equal to or less than 5 minutes more preferably less than 1 minute.

Preferably, in the process of the present invention, there is a concentration of solids to at least 45 weight percent after 20 hours from a starting MFT solution of 30 weight percent solids. Preferably there is continued thickening with an increase of solids to 50 weight percent or more over a timeframe of 100 to 1000 hours.

In one embodiment of the process of the present invention (A) shown in FIG. 1, the flocculated MFT is transported to a thin lift sloped deposition site 50 having a slope of 1 percent to 4 percent to allow water drainage. This water drainage allows the material to dry at a more rapid rate and reach trafficability levels sooner. Additional layers can be added and allowed to drain accordingly.

In another embodiment of the process of the present invention (B) shown in FIG. 1, the flocculated MFT is transferred via line 17 to a centrifuge 60. A centrifuge cake solid containing the majority of the fines and a relatively clear centrate having low solids concentrations are formed in the centrifuge 60. The centrifuge cake can then be transported, for example, by trucks or pipelines, and deposited in a drying cell.

In a further embodiment of the process of the present invention (C) shown in FIG. 1, the flocculated MFT is transported and placed in a thickener 70, said thickener 70 may comprise rakes (not shown in FIG. 1), to produce clarified water and thickened tailings for further transport and disposal.

Yet a further embodiment of the process of the present invention (D) is shown in FIG. 1, the flocculated MFT is deposited at a controlled rate into a dewatering cell 80, for example a tailings pit, basin, dam, culvert, or pond, or the like which acts as a fluid containment structure. The subsequent rate of dewatering of the treated tailings can be enhanced using accelerated dewatering techniques. The containment structure may be filled with flocculated MFT continuously or the treated MFT can be deposited in layers of varying thickness. The water released may be removed using pumps (not shown in FIG. 1) followed by additional placement of acoustically and chemically treated tailings. The deposit fill rate is such that maximum water is released during or just after deposition. Preferably, the deposited particulate mineral material will reach a substantially dry state. In addition the particulate mineral material will typically be suitably consolidated and firm e.g., due to simultaneous settling and dewatering to enable the land to bear significant weight.

The present invention provides improved methods of mixing that more efficiently combine the flocculant and tailings stream, in terms of treatment time, ability to treat higher solids streams, and ability to add flocculant in various physical states (solids, slurries, solutions, and the like).

### EXAMPLES

### Examples 1 to 4

A 0.5 wt % aqueous stock solution of polyethylene oxide (PEO) having a molecular weight of 8,000,000 Da available as UCAR FLOC™ 309 from The Dow Chemical Company are prepared by dissolution of the PEO in process water with magnetic mixing. Solutions are equilibrated without stirring for at least another 2 hours prior to use. Oil sands MFT tailings diluted to 30 wt % solids are shaken for 10 minutes in a horizontal shaker before dispensing about 5 g by pipette into 10 mL glass vials.

Acoustic mixing of the flocculant solution and tailings is accomplished using a xn RESODYN™ LABRAM Mixer (Butte, Mont.). The tailings and any process water needed to maintain the desired solids loading are added by pipette to a 10 mL glass vial; and initially combined using brief exposure to a vortex mixer. Polymer solution is added by pipette to the vial to provide 1,000 ppm PEO with respect to the tailings solids. The vial is capped and placed in the acoustic mixer for the desired mixing time and intensities. The intensities for Examples 1 to 4 are as follows: Example 1 is 50% intensity, Example 2 is 60% intensity, Example 3 is 70% intensity, and Example 4 is 80% intensity. After the acoustic mixing for various times, in seconds, the vials are immediately transferred to a liquid handling robot (Symyx Extended Core Module, Sunnyvale, Calif.) for imaging. An image of the sample is collected every minute for the first 15 minutes of settling; a final image is collected after 20 hours. The digital images are processed with an algorithm to determine the relative mud heights (normalized to the total sample height) as a function of settling time.

The settling results for Examples 1 to 4 are provided in Table 1.

TABLE 1

| | |
|---|---|
| Normalized Mud Height | Example |

| after 20 hours | 1 | 2 | 3 | 4 |
|---|---|---|---|---|
| @ mixing for 10 sec | 0.85 | 0.757 | 0.755 | 0.726 |
| @ mixing for 20 sec | 0.695 | 0.708 | 0.707 | 0.716 |
| @ mixing for 30 sec | 0.715 | 0.746 | 0.753 | 0.721 |
| @ mixing for 60 sec | 0.683 | 0.631 | 0.722 | 0.755 |

Good water release is observed over the range of intensities from 50 to 80%, in as little as 10 seconds mixing time, demonstrating the effectiveness of acoustic mixing in combining highly dissimilar viscosity liquids (tailings and flocculant solution). Higher mixing intensities (60-80%) improve the water release at short mixing times (10 seconds).

### Examples 5 to 11

A 0.4 wt % aqueous stock solution of polyethylene oxide (PEO) having a molecular weight of 8,000,000 Da available as POLYOX™ WSR-308 from The Dow Chemical Company is prepared by dissolution of the PEO in process water with magnetic mixing. Solutions are equilibrated without stirring for at least another 2 hours prior to use. Oil sands MFT tailings diluted to 30 wt % solids are weighed into 4 oz plastic jars, and mixed with a spatula to incorporate the dilution water. The aqueous polymer flocculant solution is added by pipet to provide 1,000 ppm PEO with respect to the dry tailings solids, and the jar is capped and placed in the sample chamber of the acoustic mixer. A total weight of approximately 100 g is mixed at a time for 30 or 60 seconds at 60, 70 or 80% mixing intensity Immediately after mixing, the contents of the jars are carefully and rapidly transferred to 100 mL glass graduated cylinders for settling. Images of the cylinders as a function of settling time are collected using a digital camera.

Compositions, mixing parameters, and water release after 20 hours for Examples 5 to 11 are shown in Table 2.

TABLE 2

| Example | 5 | 6 | 7 | 8 | 9 | 10 | 11* |
|---|---|---|---|---|---|---|---|
| PEO, ppm | 1000 | 1000 | 1000 | 1000 | 1000 | 1000 | 0 |
| Intensity, % | 60 | 60 | 70 | 70 | 80 | 80 | 80 |
| Mixing Time, sec | 30 | 60 | 30 | 60 | 30 | 60 | 30 |
| Final MFT Solids, % | 30 | 30 | 30 | 30 | 30 | 30 | 30 |
| MFT Sample Size, g | 66.5 | 66.5 | 66.5 | 66.5 | 66.5 | 66.5 | 66.5 |
| PEO Solution, mL | 6.9 | 6.9 | 6.9 | 6.9 | 6.9 | 6.9 | 0 |
| Process Water, mL | 41.6 | 41.6 | 41.6 | 41.6 | 41.6 | 41.6 | 48.5 |
| Solids, % | 40.8 | 39.1 | 40.9 | 38.2 | 40.9 | 36.5 | 30.3 |
| Water Release, % | 38 | 33 | 38 | 30 | 38 | 25 | 1 |

*Not an Example of the invention

### Examples 12 to 19

A 0.4 wt % aqueous stock solutions of polyethylene oxide (PEO) having a molecular weight of 8,000,000 Da available as POLYOX WSR-308 from The Dow Chemical Company is prepared by dissolution of the PEO in process water with magnetic mixing. Solutions are equilibrated without stirring for at least another 2 hours prior to use. An oil sands MFT tailings, different from the one evaluated in Examples 1 to 12, diluted to 34.6 wt % solids are weighed into 4 oz plastic jars, and mixed with a spatula to incorporate the dilution water. The aqueous polymer flocculant solution is added by pipet to provide 1,000 ppm of PEO with respect to the tailings solids, and the jar is capped and placed in the sample chamber of the acoustic mixer. A total weight of approximately 100 g is mixed at a time for 30 or 60 seconds at 50, 60, 70 or 80% mixing intensity Immediately after mixing, the contents of the jars are carefully and rapidly transferred to 100 mL glass graduated cylinders for settling. Images of the cylinders as a function of settling time are collected using a digital camera.

Compositions, mixing parameters, and water release after 20 hours for Examples 12 to 19 are shown in Table 3.

TABLE 3

| Example | 12 | 13 | 14 | 15 | 16 | 17 | 18 | 19* |
|---|---|---|---|---|---|---|---|---|
| PEO, ppm | 1000 | 1000 | 1000 | 1000 | 1000 | 1000 | 1000 | 0 |
| Intensity, % | 50 | 60 | 60 | 70 | 70 | 80 | 80 | 60 |
| Mixing Time, sec | 30 | 30 | 60 | 30 | 60 | 30 | 60 | 30 |
| Final MFT Solids, % | 31.8 | 31.8 | 31.8 | 31.8 | 31.8 | 31.8 | 31.8 | 31.8 |
| MFT Sample Size, g | 99.6 | 99.6 | 99.6 | 99.6 | 99.6 | 99.6 | 99.6 | 99.6 |
| PEO Solution, mL | 9.4 | 9.4 | 9.4 | 9.4 | 9.4 | 9.4 | 9.4 | 0 |
| Process Water, mL | 8.4 | 8.4 | 8.4 | 8.4 | 8.4 | 8.4 | 8.4 | 17.7 |
| Solids, % | 35.5 | 36.3 | 35.2 | 36.8 | 35.1 | 36.4 | 33.3 | 32 |
| Water Release, % | 15 | 18 | 14 | 20 | 14 | 18 | 7 | 1 |

*Not an example of the invention

What is claimed is:

1. A process for flocculating and dewatering a mineral suspension, comprising the steps:
i) providing a mineral suspension to an acoustic mixer,
ii) providing a flocculant composition to said acoustic mixer,
and
iii) acoustically mixing the mineral suspension and the flocculant composition to provide a flocculated mineral suspension.

2. The process of claim 1 wherein the flocculant is added to the mineral suspension before, during, or after addition to the acoustic mixer.

3. The process of claim 1 further comprising the step
ii) a) providing a coagulant to said acoustic mixer.

4. The process of claim 1 further comprising the step:
iv) adding the flocculated mineral suspension to at least one centrifuge to dewater the flocculated mineral suspension and form a high solids cake and a low solids centrate.

5. The process of claim 1 further comprising the step:
v) adding the flocculated mineral suspension to a thickener to dewater the flocculated mineral suspension and produce a thickened mineral suspension and clarified water.

6. The process of claim 1 further comprising the step:
vi) adding the flocculated mineral suspension to at least one deposition cell such as an accelerated dewatering cell for dewatering.

7. The process of claim 1 further comprising the step:
vii) spreading the flocculated mineral suspension as a thin layer onto a sloped deposition site.

8. The process of claim 1 wherein the mineral suspension is an aqueous suspension of oil sands tailings.

9. The process of claim 1 wherein the flocculant composition comprises one or more of a polyacrylate, a polymethacrylate, a polyacrylamide, a partially-hydrolyzed polyacrylamide, a poly(ethylene oxide) homopolymer, a poly(ethylene oxide) copolymer, a cationic derivatives of polyacrylamide, a polydiallyldimethylammonium chloride (pDADMAC), a copolymer of DADMAC, a cellulosic material, a chitosan, a sulfonated polystyrene, a linear and/or branched polyethyleneimine, a polyvinylamine, a polyalkylene glycol, a polyquat/hyalauronic acid, a polyacrylic, a polyacrylamide (acrylic acid) copolymer, a poly(acrylamide-co-diallyl dimethylammonium chloride), guar, a hydrophobically alkali-soluble emulsion, an alkali-swellable emulsion, a hydrophobically modified ethoxylated urethane polymer, or mixtures thereof.

10. The process of claim 1 wherein the flocculant composition comprises a poly(ethylene oxide) (co)polymer composition comprising a poly(ethylene oxide) homopolymer, a poly(ethylene oxide) copolymer, or mixtures thereof.

11. The process of claim 10 wherein the poly(ethylene oxide) copolymer is a copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

12. The process of claim 10 wherein the poly(ethylene oxide) (co)polymer has a molecular weight of equal to or greater than 1,000,000 Da.
